(19) United States
(12) Patent Application Publication
(10) Pub. No.: US 2022/0235820 A1
(43) Pub. Date: Jul. 28, 2022

(54) DEVICE FOR THE MANUFACTURE OF ELASTIC BUSHINGS

(71) Applicant: Mattias HVASS, Skå (SE)

(72) Inventor: Mattias HVASS, Skå (SE)

(21) Appl. No.: 17/615,180

(22) PCT Filed: Jun. 5, 2020
(86) PCT No.: PCT/SE2020/050570

§ 371 Date: Nov. 30, 2021

(30) Foreign Application Priority Data
Jun. 7, 2019 (SE) 1900102-3

(51) Int. Cl. F16C 33/14; B29C 55/22; B29C 61/08; B25B 27/28; F16C 27/06

(52) U.S. Cl. CPC F16C 33/14; B29C 55/22; B29L 2031/045; B25B 27/28; F16C 27/063; B29C 61/08

(57) ABSTRACT

A device for manufacturing bushings faster and for allowing a continuous manufacture process is provided. An elastic material with a bigger cross section area can be assembled between outer and inner sleeves with smaller cross section area. Many bushings can be assembled at the same time in each production cycle. The elastic material can be pressed together in one gripping element and stretched over a second gripping element before gripping and stretching take place.

The present invention relates to a device for manufacturing elastic bushings and elastic bushings manufactured with this device.

Elastic bushings often consist of an outer sleeve and an inner sleeve, and an elastic element arranged between the sleeves. The elastic element is normally “placed in position” as a rubber to metal moulded finished part via a vulcanisation process. Or with a semi-process where rubber is only vulcanised onto the inner sleeve, which part is later pushed into one outer sleeve trough a conical shaped press tool. At vulcanisation process a natural tension is created in the rubber because of shrinkage effect after the hot floating rubber has been vulcanized and stabilized into a higher density mode after. This is reason why a full vulcanized part needs to be calibrated via compressing the outer sleeve together to make it smaller or expand the inner sleeve to make it bigger, so that the natural tension in the rubber gets neutralized. In the semi-process this calibration is not needed. In the semi-process it is possible to make the rubber part with little bigger outer diameter than the inner diameter of the outer sleeve. When later pressing rubber with bigger diameter into a sleeve with smaller diameter, one wished and expected radial precompression effect of the rubber element is created, which prevent the rubber/inner sleeve from falling out/change its position in the outer sleeve.

Both fully vulcanized elastic bushings and those made via semi-process need one vulcanization production done in one pressurized and heated vulcanisation machine. Such vulcanisation process can take many minutes up to an hour depending on the size of the part. How many parts that can be produced in each vulcanization cycle is depending on the number of cavities in the machine tool mould. It is therefore desirable to provide a device for manufacturing elastic bushings and bushings made with this device, which allow the production process to be both continuous and less time consuming compared with conventional vulcanization mould process. It is therefore also desirable to provide a possibility to get the elastic element in place between the outer and the inner sleeve with little force, but also achieve the effect of wished radial precompression for the elastic element between the outer and inner sleeves, so it remains locked in position without using for example glue if not necessary.

The invention relates, according to an aspect thereof, to a device for manufacturing elastic bushings comprising at least one first gripping element 8 and a second gripping element 4. The gripping elements comprise openings for receiving an elastic element 3 and grasping it. A primary gripping element 4, 8 is designed to allow reception of outer sleeves l around the primary gripping element 4, 8 before it grips the elastic element 3 and a secondary gripping element 4, 8 is configured to allow reception of inner sleeves 2 trough it while it keep holds the elastic element in stretch. The outer sleeves 1 and inner sleeves 2 can thus advantageously be pushed in place on over and into the elastic element 3, completely without having to apply any significant force.

In an advantageous embodiment, the device is provided with a stretching device, which can provide offset the first gripping element 8 from the second gripping element 4. In this way, the resilient element 3 can be stretched until it becomes so thin walled that the outer and inner sleeves can be pushed on over respectively into the elastic element. When the stretching ceases, the wall thickness of the elastic element 3 will increase and intend to return to its original thickness until it hits the walls of outer and inner sleeves and tensions will occur between outer and inner sleeves, provided the original thickness is bigger than the radial distance between inner and outer sleeves. This advantageously means that no glue is necessary to retain the elastic element in place. The invention also relates, according to another aspect thereof, to an elastic bushing made with such a device.

### BRIEF DESCRIPTION OF THE FIGURES

FIG. 1 shows an embodiment of a device for manufacturing bushings in partial cross-section. The outer sleeves 1 have been pushed over the gripping element 8 before this gripping element is gripping around one side of the elastic material 3. Four outer sleeves are illustrated to have been put in place on the extended arm. The number of sleeves is limited to how long the extended holding arm is of gripper arm 6.

FIG. 2 shows an embodiment of a first gripping element 8 for an elastic element in a cross section perpendicular to the centre axis of the gripping element. The outer diameter of the gripping element 8 must always be at least minimal smaller than the inner diameter of the outer sleeves 1 that are pushed over it.

FIG. 3 shows one possible embodiment of the first gripping element 8 for an elastic element in a cross section parallel to the centre axis of the gripping element.

FIG. 4 shows a second gripping element 4 for an elastic element in a cross section perpendicular to the centre axis of the gripping element. The inner diameter of the gripping elements inner tube 15 is always at least minimal bigger than the outer diameter of the inner sleeves 2 that are pushed through this second gripping element 4 at the assembly of the elastic bushings.

FIG. 5 shows one elastic bushing in cross section before it is ready produced with the invention device. The elastic element 3 is in this stage one extended sheet of elastic material in a circle shape. The radial cross section area of the elastic element has decreased so that an air gap is shown between the elastic element and each sleeve as well as between edges of the sheet 18 in axial direction.

FIG. 6 shows one elastic bushing in cross section when it is ready produced. The radial air gap between elastic element and sleeves is gone as well as the gap between the elastic elements' axial direction edges 18.

FIG. 7 shows one elastic bushing in cross section before it is ready produced with the invention device. The elastic element 3 is in this stage one extended tube of elastic material. The radial cross section area of the elastic element has decreased so that an air gap is shown between the elastic element and each sleeve,

FIG. 8 shows one elastic bushing in cross section when it is ready produced and when the elastic element 3 is made from a tubular element. The radial air gap between elastic element 3 and sleeves 1 and 2 is gone.

### DETAILED DESCRIPTION

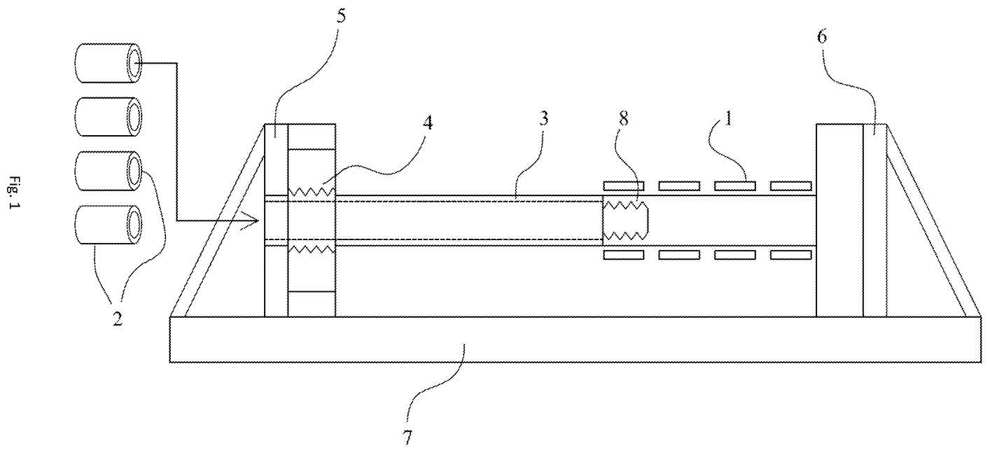

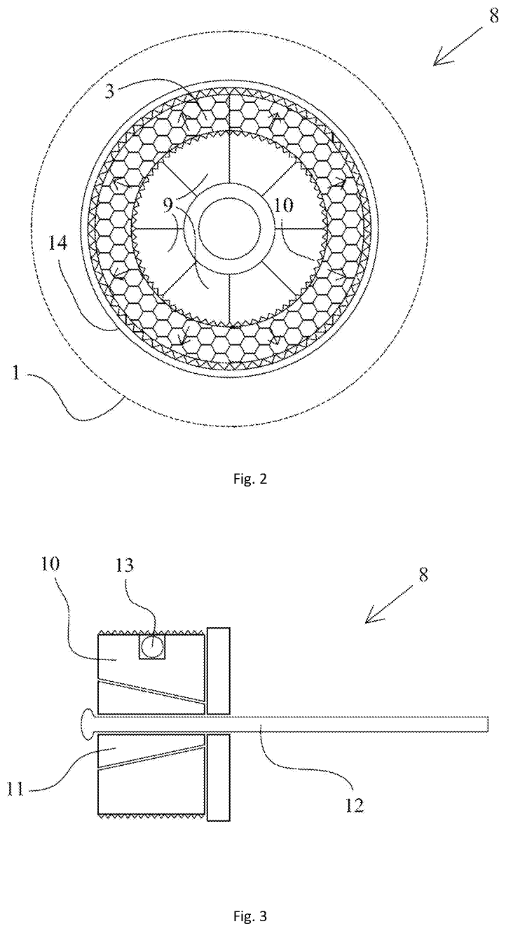

The invention relates to a device for manufacturing elastic bushings and elastic bushings made with this device. The device is illustrated here in one embodiment of FIG. 1, while details of the construction is illustrated in FIGS. 2-4. Bushings include an outer sleeve 1 and an inner sleeve 2, typically of metal and normally both are of the same material. The outer and inner sleeves can alternatively for example be made of plastic, glass fibre or carbon fibre.

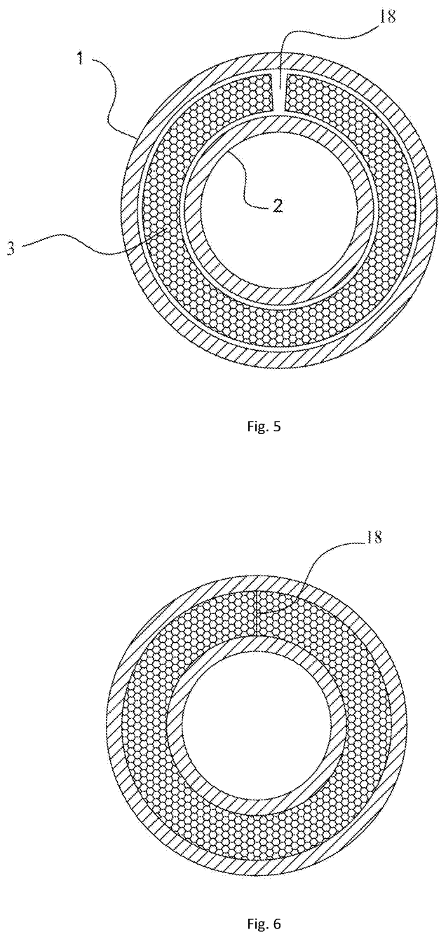

Between the outer and inner sleeves is arranged a ring of elastic material 3, typically of rubber, but it can be made from many other elastic materials. The elastic material 3 in FIGS. 2, 4, 5, 7, 8 is drawn with a honeycomb pattern to be easily distinguished from other elements.

The ring of elastic material 3 that is illustrated in FIGS. 2, 4, 5, 6, 7, 8 is a cross-section and is made of pipe or near tubular elements.

The device for manufacturing elastic bushings is based on stretching the resilient material 3 so that it shrinks in the propagation directions other than the stretching direction. The stretching direction is parallel to the centre axis of the bushing, which in FIGS. 1 and 3 extends to the right and left direction in the paper plane, while the centre axis of the bushings in FIGS. 2, 4, 5 and 6 is directed out of and into the paper plane.

FIG. 1 shows an embodiment of a device for manufacturing bushings in partial cross-section. The device extends on a rigid supporting construction carrier 7 on which are arranged two gripping arms 5-6, i.e. the right gripping arm 6 near the right end of the supporting construction carrier 7 and the left gripping arm 5 close the left end of the supporting construction carrier 7.

The gripping arms comprise gripping elements 4, 8 which grip it the elastic material 3. The gripping elements 4, 8 thus grip the tubular elastic material 3 and extends it in its longitudinal direction, i.e. the centre axis of the future bushes which extend through the device in the right and left directions.

The stretching of the gripping arms 5-6 is accomplished with a motorized element not illustrated or further explained, but most likely via a hydraulic cylinder or electrical engine driven screw.

The stretching in the direction along the centre axis of the bushes causes the tubular elastic material 3 wall thickness becomes thinner and makes it possible to assemble outer and inner sleeves around it without any major friction force between the surfaces. This is illustrated in the FIG. 1 with four outer sleeves 1 arranged on and to the right of the gripping element 8, which need to be put there before the elastic material is taken into the gripping element 8.

The inner sleeves 2 that are illustrated outside left gripping arm 5 can be pushed into he interior of the tubular elastic material 3 through the left gripping element 4.

When a desired number of outer sleeves 1 and inner sleeves 2 are arranged, adjacent to the tubular the elastic material 3 can cease stretching. It has so far stretched along its longitudinal axis, thus the elastic material 3 shrinks in the longitudinal axis direction, while that of the elastic material wall thickness increases when return to original shape. The increase in wall thickness is such that the elastic material falls into compression between the outer sleeves 1 and the inner sleeves 2, provided that the original wall thickness of 3 is bigger than radial distance between inner and outer sleeve, so that the elastic material cannot leave its position in the bushing. This is thus obtained without the need to glue the elastic material in position or without having to compress and reduce outer diameter of the outer sleeves 1 or squeeze out to increase diameters of the inner sleeves 2.

FIG. 2 shows an embodiment of a first gripping element 8 for an elastic element in a cross Section perpendicular to the centre axis of the gripping element. The first gripping element 8 comprises a solid exterior gripping ring 14 acting against a movable inner gripping section 9. The movable inner gripping section 9 is in the figure provided with the smallest possible outer diameter but can be displaced from this position. The moving interior gripping section 9 comprises a series of circle sectors 9 arranged to form a close joint circular shape. The first gripping element has a circular hole at its centre and by insertion a conical object in this hole, the circle sectors 9 are forced to be radially pushed apart. On the periphery of in the circle sectors 9 which jointly cars a circle, teeth 10 are provided which engage outwardly. The first gripping element 8 comprises a fixed outer grip ring 14 which is concentrically arranged around the movable inner grip portion 9 with a gap in between. The fixed outer grip ring 14 has on its inner surface illustrated with teeth for a rough surface arranged inwardly, which shall increase friction against the elastic material when gripping element is gripping it. The tubular elastic material 3 extends concentrically between the fixed outer gripping ring 14 and the movable inner gripping section 9. The tubular elastic material 3 abuts, as well the teeth of the gripping surface 10 as against the teeth of the fixed gripping ring 14. By radially forcing the circle sectors 9 apart centre of the gripping element, the first gripping element engages the tubular elastic material 3. The tubular elastic material 3 can now be extended in length as soon as also gripping element 4 has made its equal gripping.

With the tubular elastic material 3 in later stretched position, outer sleeves 1 can later be pushed on the outside of the tubular elastic material 3 without having to push them with a major force because the outer diameter of the tubular elastic material will be smaller than the inner diameter of the outer sleeves 1. The outer sleeves were prepared and put onto the gripping arm before gripping the elastic material for stretching.

FIG. 3 shows the embodiment of the movable inner gripping section 9 on the first gripping element 8 for one elastic element, in a cross-section parallel to the centre axis of the gripping element. Here shows one example of how the circular sectors 9 can be radially forced apart from the centre of the gripping element. It is shown here that the cross-sectional hole in the centre of the gripping element is conical and its interior receives a cone 11 . The cone 11 is displaced axially in the conical hole in the centre of the gripping element, the circular sectors 9 are forced apart radially from the centre: of the gripping section. A guide wire 12 grips the cone 11 and by pulling in the guide wire 12 this radial movement of the circle sectors is achieved.

Around the circular sectors 9 extends a resilient element 13 which strives to bring back the circular sectors 9 towards the centre of the grip element. Discontinues the force of the control wire 12, displaced the cone 11 returns to its unloaded position and the circle sectors 9 move radially inward until they lie edge to edge with each other again.

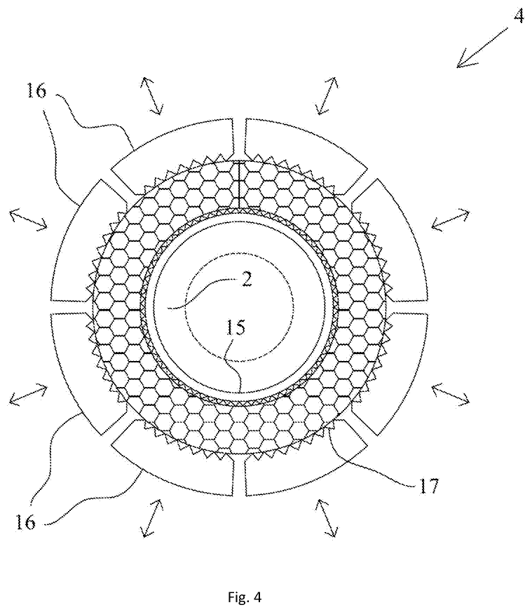

FIG. 4 shows a second gripping element 4 for gripping the elastic element, in a cross section perpendicular to the centre axis of the gripping element. The second gripping element 4 comprises a fixed inner gripping ring 15 which acts against movable outer gripping sections 16. The movable outer gripping sections 16 are arranged in the figure with a small inner diameter, but can be radially displaced from this position to provide both larger inner diameters to receive the tubular elastic material 3 or provide one smaller inner diameter to clamp the tubular elastic material 3.

The gripping sections 16 comprises a series of circular sectors with a circular truncation around the centre, arranged so that they jointly form a near circular shape. On the inner surfaces of the circle sectors, teeth 17 are provided which engage inward.

The fixed inner gripping ring 15 has on its outer surface teeth which engage outwardly.

The control arrangement for effecting the radial displacement of the truncated circle sectors 16 are not illustrated but can be achieved in an equal manner like with first gripping element 8. The radial movement of the truncated circular sectors is illustrated by radial bidirectional arrows. The tubular elastic material 3 extends concentrically between the solid inner gripping ring 15 and the movable gripping sectors 16. The tubular elastic material 3 abuts as well the teeth 17 on gripping sectors 16 as the teeth of the fixed inner gripping ring 15.

By radially forcing the truncated circular sectors 16 toward the centre of the gripping element 4, the second gripping element 4 engages and fix the tubular elastic material 3. The tubular elastic material 3 can now be stretched out in its length. With the tubular elastic material 3 in this stretched position, inner sleeves 2 can be pushed inside the tubular elastic material 3 without any major force.

In the illustrated embodiment, the elastic material at the beginning of production is one rectangular disc, which is forced to assume a close tubular shape. The elastic material edges reach then each other forming a rupture 18 which is seen to divide the elastic material at the top of FIGS. 2, 4, 5, 6.

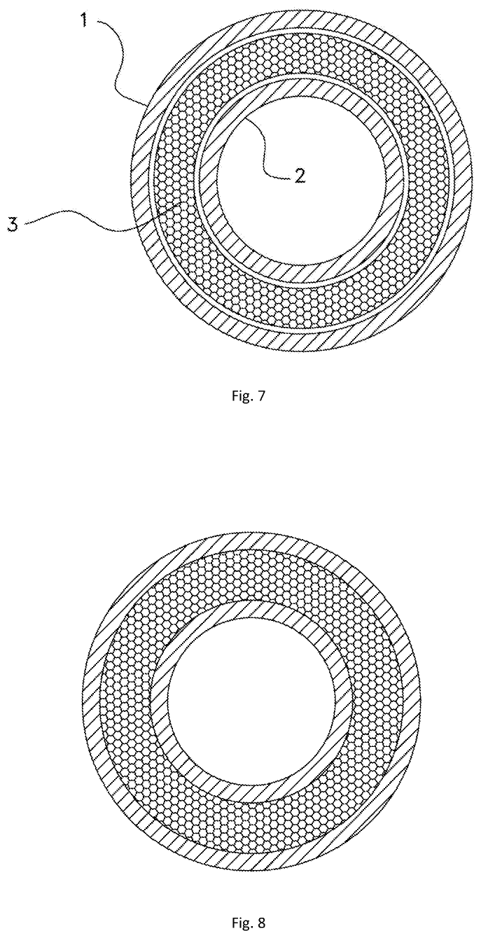

Of course, the elastic material can initially be a tube instead for a rolled sheet and do then not have any illustrated cut 18. See FIGS. 7 and 8 for a semi-finished and finished bushing with tubular elastic material 3 inside.

The bushes in the illustrated embodiment are circular and the gripping elements 4, 8 are adapted to this, but bushings can be of any other shape, for example square. For a square bushing, the gripping elements 4, 8 are adapted to this with square moving gripping element parts as well as the described embodiments of solid inner tube 15 and outer grip tube 14, respectively.

Bushings differently shaped than a circle, usually denoted differently, but to obtain consistency, these two elements are designated inner grip tube 15 and outer grip tube 14 independently, respectively their actual form.

For the device to be able to force the elastic material into a close tube shape and extend and stretch it, gripping elements 4, 8 must be present at each end of the elastic material. The gripping elements 4, 8 then tend to block the ends of the tubular elastic material, either to make it difficult or impossible to move and inserting an inner sleeve into the elastic material or making it difficult or impossible to pull an outer sleeve around the perimeter of the elastic material.

By gripping the elastic material with the first type of gripping element 4 at one end, inner sleeves 2 can later be inserted into the interior of the tube 15 that is part of the gripping element 4 and its gripping arm 5. The all trough opening for the inner sleeves 2 is never blocked, else than by the elastic material 3 in unstretched position.

By gripping the elastic material with the second type of gripping element 8 at the other end, outer sleeves 1 , that beforehand has been put in waiting position onto the extended tube like arm 14 of the gripping arm 6, can later easy be pushed over the elastic materials outer surface when the stretching is made.

The inner diameter of the gripping element 4 should optimally be marginally larger than the outer diameter of inner sleeves 2 to allow passage of the inner sleeves 2 through the gripping element 4.

On a correspondingly, the optimum outer diameter of gripping element 8 should be marginally smaller than inner diameter of the outer sleeves 1 to allow free passage of the outer sleeves over gripping element 8.

If more than one set of inner and outer sleeves are used, they need later to be separated via cutting the elastic material through. This can be done with knife or water cut.

The key to the method itself when using the invention device is that the elastic material can be pressed together in one gripping element and stretched over second gripping element before gripping and stretching take place. To use the right sequence in combination of the two different gripping elements and their unique relative dimensions versus inner and outer sleeves.

1. A device for manufacturing elastic bushings comprising at least a first gripping element and a second gripping element, wherein the gripping elements comprise openings for receiving and gripping a tubular elastic element, wherein the first gripping element is designed to allow reception of an outer sleeve or sleeves over the first gripping element, wherein the second gripping element is configured to allow reception of an inner sleeve or sleeves through the inner of the second gripping element, wherein the elastic bushings manufacturing device comprises a tensioning device, which can displace the first gripping element from the second gripping element so as to extend the tubular elastic element wherein the elastic bushings manufacturing device comprises a rigid supporting construction carrier, on which are arranged two gripping arms, wherein a first gripping arm is arranged near a first end of the rigid supporting construction carrier and a second gripping arm is arranged near a second end of the rigid supporting construction carrier, wherein the first gripping arm comprises the first gripping element and the second gripping arm comprises the second gripping element, wherein the gripping elements are arranged to grip the tubular elastic element at a respective end of the tubular elastic element and extend it in its longitudinal direction, wherein the first gripping arm is adapted to receive outer sleeve or sleeves in waiting position for being pushed over the tubular elastic element when the tubular elastic element is in a stretched state and wherein the second gripping arm is adapted to receive inner sleeve or sleeves for insertion into the tubular elastic element when the tubular elastic element is in the stretched state.

2. An elastic bushings manufacturing device according to claim 1, wherein the first gripping element is designed with an outer diameter that is minimal smaller than an inner diameter of the outer sleeve or sleeves.

3. An elastic bushings manufacturing device according to claim 1, wherein the first gripping element comprises a fixed outer grip ring and a movable inner grip portion, wherein the fixed outer grip ring is concentrically arranged around the moveable inner grip portion, wherein the fixed outer grip ring and the movable inner grip portion are adapted to engage the tubular elastic element.

4. An elastic bushings manufacturing device according to claim 1, wherein the second gripping element is designed with an inner diameter that is minimal bigger than an outer diameter of the inner sleeve or sleeves.

5. An elastic bushings manufacturing device according to claim 1, wherein the second gripping element comprises a fixed inner grip ring and movable outer gripping sections, wherein the fixed inner grip ring and the movable outer gripping sections are adapted to engage the tubular elastic element.

6. A method for manufacturing an elastic bushing, wherein the method comprises
providing a tubular elastic element, an inner sleeve and an outer sleeve, wherein the tubular elastic element is provided with an original wall thickness that is bigger than a radial distance between the inner sleeve and the outer sleeve,
putting the outer sleeve in a waiting position on a gripping arm before the tubular elastic element is gripped,
gripping the tubular elastic element at each end of tubular elastic element in a longitudinal direction of the tubular elastic element,
stretching the tubular elastic element in the longitudinal direction so that the wall thickness of the tubular elastic element becomes thinner,
assembling the inner sleeve inside of the tubular elastic element from a first end of the tubular elastic element in the longitudinal direction and the outer sleeve outside of the tubular elastic element from a second end of the tubular elastic element in the longitudinal direction when the tubular elastic element is in a stretched state, and
ceasing stretching of the tubular elastic element after assembly of the inner sleeve and the outer sleeve, wherein the tubular elastic element tends to return to its original shape so that the tubular elastic element falls into compression between the inner sleeve and the outer sleeve.

7. A method according to claim 6, wherein the method comprises
pressing a first end of the tubular elastic element into a first gripping element, and
stretching a second end of the tubular elastic element over a second gripping element before gripping and stretching.
